(19) United States
(12) Patent Application Publication
(10) Pub. No.: US 2015/0049284 A1
(43) Pub. Date: Feb. 19, 2015

(54) DISPLAY PANEL FOR COMPENSATING A VIEWING ANGLE AND DISPLAY APPARATUS HAVING THE SAME

(71) Applicant: SAMSUNG ELECTRONICS CO., LTD., Suwon-si (KR)

(72) Inventors: Il-yong JUNG, Yongin-si (KR); Tsukasa YAMADA, Suwon-si (KR); Seong-eun CHUNG, Seoul (KR); Seung-myen LEE, Suwon-si (KR)

(73) Assignee: SAMSUNG ELECTRONICS CO., LTD., Suwon-si (KR)

(21) Appl. No.: 14/245,080

(22) Filed: Apr. 4, 2014

(30) Foreign Application Priority Data
Aug. 13, 2013 (KR) 10-2013-0096121

(51) Int. Cl. G02F 1/13363

(52) U.S. Cl. CPC G02F 1/13363
USPC 349/96

(57) ABSTRACT

A liquid crystal display (LCD) panel is provided. The LCD panel includes: a liquid crystal layer configured to operate in a first preset phase retardation mode based on an operating mode of liquid crystals; a pre-tilt layer configured to guide a rotation direction of the liquid crystals; a polarizing layer formed on a surface of the upper substrate and having a wire grid structure to polarize and filter radiated light passing through the liquid crystal layer; and a retardation compensation film disposed between the polarizing layer and the upper substrate and configured to compensate phase retardation of the radiated light, wherein the retardation compensation film includes: a first compensation layer configured to retard the radiated light in a second phase retardation mode having a negative phase retardation; and a second compensation layer configured to retard the radiated light in a third phase retardation mode.

### CROSS-REFERENCE TO RELATED APPLICATION

This application claims priority from Korean Patent Application No. 10-2013-0096121, filed on Aug. 13, 2013 in the Korean Intellectual Property Office, the disclosure of which is incorporated herein by reference, in its entirety.

### BACKGROUND

1. Technical Field

Apparatuses and methods consistent with the exemplary embodiments relate to a display panel which displaying an image and a display apparatus having the same. More particularly, the exemplary embodiments relate to a display panel having an improved structure for compensating a viewing angle as a liquid crystal display panel which displays an image using light provided from a backlight, and a display apparatus having the same.

2. Description of the Related Art

A display apparatus is a device which includes a display panel which displays images to present broadcast signals, or various formats of image signals or image data, and is configured as a TV, a monitor, or the like. The display panel is implemented as various types of devices, for example, a liquid crystal display (LCD) panel and a plasma display panel (PDP), based on characteristics thereof, and is employed for a variety of display apparatuses. In response to an LCD panel being unable to generate light by itself is used as the display panel, the display apparatus includes a backlight to generate light and provide the light to the display panel.

The LCD panel includes various films to adjust characteristics of light provided from the backlight, in which light loss occurs in response to light entering the panel exits from the panel via a liquid crystal layer and films. The films include a polarizing film which filters a polarized component in a particular direction, which may absorb a polarized component in a particular direction, causing remarkable light loss. Further, as a change in contrast ratio by a viewing angle and gray scale inversion may reduce visibility, it is important for the LCD panel to obtain a structure for securing a viewing angle.

### SUMMARY

A liquid crystal display (LCD) panel including: a lower substrate; an upper substrate disposed to face the lower substrate; a liquid crystal layer disposed between the lower substrate and the upper substrate and configured to operate in a first preset phase retardation mode based on an operating mode of liquid crystals; a pre-tilt layer configured to guide a direction of rotation of the liquid crystals in response to the liquid crystal layer operating; a polarizing layer formed on a surface of the upper substrate and having a wire grid structure to polarize and filter radiated light passing through the liquid crystal layer; and a retardation compensation film disposed between the polarizing layer and the upper substrate and configured to compensate phase retardation of the radiated light caused by the liquid crystal layer and the pre-tilt layer, wherein the retardation compensation film includes: a first compensation layer configured to retard the radiated light in a second phase retardation mode having a negative phase retardation in contrast with the first phase retardation mode of the liquid crystal layer; and a second compensation layer configured to retard the radiated light in a third phase retardation mode set to be switched to the second phase retardation mode in response to being combined with the pre-tilt layer.

Thickness of the first compensation layer and thickness of the second compensation layer may be proportionate to the density of the liquid crystals per unit volume in the liquid crystal layer.

The thickness of the second compensation layer may be configured to retard the amount of light retarded by the pre-tilt layer, and the thickness of the first compensation layer may be configured to offset a phase difference of light retarded by the liquid crystal layer in combination with the second compensation layer.

The liquid crystal layer may operate in any one of a twisted nematic (TN) mode, a super twisted nematic mode (STN), an in-plane switching (IPS) mode and a vertical alignment (VA) mode, based on the operating mode of the liquid crystals.

The phase retardation modes may include a C plate mode and an A plate mode classified according to an optical axis, and in response to the liquid crystal layer operating in a VA mode, the first phase retardation mode of the liquid crystal layer may be a +C plate mode, the phase retardation mode of the pre-tilt layer may be a +A plate mode, the second phase retardation mode may be a −C plate mode, and the third phase retardation mode may be a +A plate mode having a 90-degree tilted optical axis.

In response to the pre-tilt layer having the +A plate mode and the second compensation layer having the +A plate mode which has a 90-degree tilted optical axis being combined, the radiated light may be retarded by the −C plate mode.

A display apparatus including: a display panel; and a backlight configured to provide light to the display panel in order to display an image, the display panel including: a lower substrate; an upper substrate disposed to face the lower substrate; a liquid crystal layer disposed between the lower substrate and the upper substrate and configured to operate in a first preset phase retardation mode based on an operating mode of liquid crystals; a pre-tilt layer configured to guide a direction of rotation of the liquid crystals in response to the liquid crystal layer operating; a polarizing layer formed on a surface of the upper substrate and having a wire grid structure to polarize and filter radiated light which passes through the liquid crystal layer; and a retardation compensation film disposed between the polarizing layer and the upper substrate and configured to compensate phase retardation of the radiated light caused by the liquid crystal layer and the pre-tilt layer, the retardation compensation film including: a first compensation layer configured to retard the radiated light in a second phase retardation mode having a negative phase retardation in contrast with the first phase retardation mode of the liquid crystal layer; and a second compensation layer configured to retard the radiated light in a third phase retardation mode which is switched to the second phase retardation mode in response to being combined with the pre-tilt layer.

Thickness of the first compensation layer and thickness of the second compensation layer may be proportionate to the density of the liquid crystals, per unit volume, in the liquid crystal layer.

The thickness of the second compensation layer may be determined to retard the amount of light retarded by the pre-tilt layer and the thickness of the first compensation layer may be determined to offset a phase difference of light retarded by the liquid crystal layer in combination with the second compensation layer.

The liquid crystal layer may operate in any one of a twisted nematic (TN) mode, a super twisted nematic mode (STN), an in-plane switching (IPS) mode and a vertical alignment (VA) mode, based on the operating mode of the liquid crystals.

The phase retardation modes may include a C plate mode and an A plate mode classified according to an optical axis, and in response to the liquid crystal layer operating in a VA mode, the first phase retardation mode of the liquid crystal layer may be a +C plate mode, the phase retardation mode of the pre-tilt layer may be a +A plate mode, the second phase retardation mode may be a −C plate mode, and the third phase retardation mode may be a +A plate mode having a 90-degree tilted optical axis.

In response to the pre-tilt layer having the +A plate mode and the second compensation layer having the +A plate mode which has a 90-degree tilted optical axis being combined, the radiated light may be retarded by the −C plate mode.

An aspect of an exemplary embodiment may provide a display panel including: a liquid crystal layer configured to operate in a first preset phase retardation mode; a pre-tilt layer configured to guide a rotation direction of the liquid crystals; a polarizing layer having a wire grid structure to polarize and filter radiated light passing through the liquid crystal layer; and a retardation compensation film configured to compensate phase retardation of the radiated light, the retardation compensation film including: a first compensation layer configured to retard the radiated light in a second phase retardation mode having a negative phase retardation in contrast with the first phase retardation mode of the liquid crystal layer; and a second compensation layer configured to retard the radiated light in a third phase retardation mode which is switched to the second phase retardation mode in response to being combined with the pre-tilt layer.

The phase retardation modes may include a C plate mode and an A plate mode classified according to an optical axis, and in response to the liquid crystal layer operating in a VA mode, the first phase retardation mode of the liquid crystal layer is a +C plate mode, the phase retardation mode of the pre-tilt layer is a +A plate mode, the second phase retardation mode is a −C plate mode, and the third phase retardation mode is a +A plate mode having a 90-degree tilt optical axis, wherein in response to the pre-tilt layer having the +A plate mode and the second compensation layer having the +A plate mode having the 90-degree tilt optical axis being combined, the radiated light is retarded by the −C plate mode.

The display panel may further include a lower substrate; and an upper substrate disposed to face the lower substrate.

The pre-tilt layer is configured to guide a direction of rotation of the liquid crystals in response to the liquid crystal layer operating.

The retardation compensation film is disposed between the lower substrate and the upper substrate.

The liquid crystal layer operates in any one of a twisted nematic (TN) mode, a super twisted nematic mode (STN), an in-plane switching (IPS) mode and the vertical alignment (VA) mode based on the operating mode of the liquid crystals.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is an exploded perspective view of a display apparatus, according to a first exemplary embodiment.

FIG. 2 is a cross-sectional view which illustrates a layered structure of elements of a display panel in the display apparatus FIG. 1.

FIG. 3 is a perspective view which illustrates a main part of a lower polarizing layer in the display panel of FIG. 2.

FIG. 4 schematically illustrates relationship between a liquid crystal layer, a pre-tilt layer and a retardation compensation film in the display panel of FIG. 2.

FIG. 5 is a block diagram which illustrates a configuration of a display apparatus according to a second exemplary embodiment.

### DETAILED DESCRIPTION OF THE EXEMPLARY EMBODIMENTS

Below, exemplary embodiments will be described in detail with reference to the accompanying drawings. In the following description, constituent parts or elements directly related to the exemplary embodiments will only be described, and descriptions of other parts or elements will be omitted. However, it should be noted that the omitted parts or elements are not construed as being unnecessary in configuring a device or system according to the exemplary embodiments.

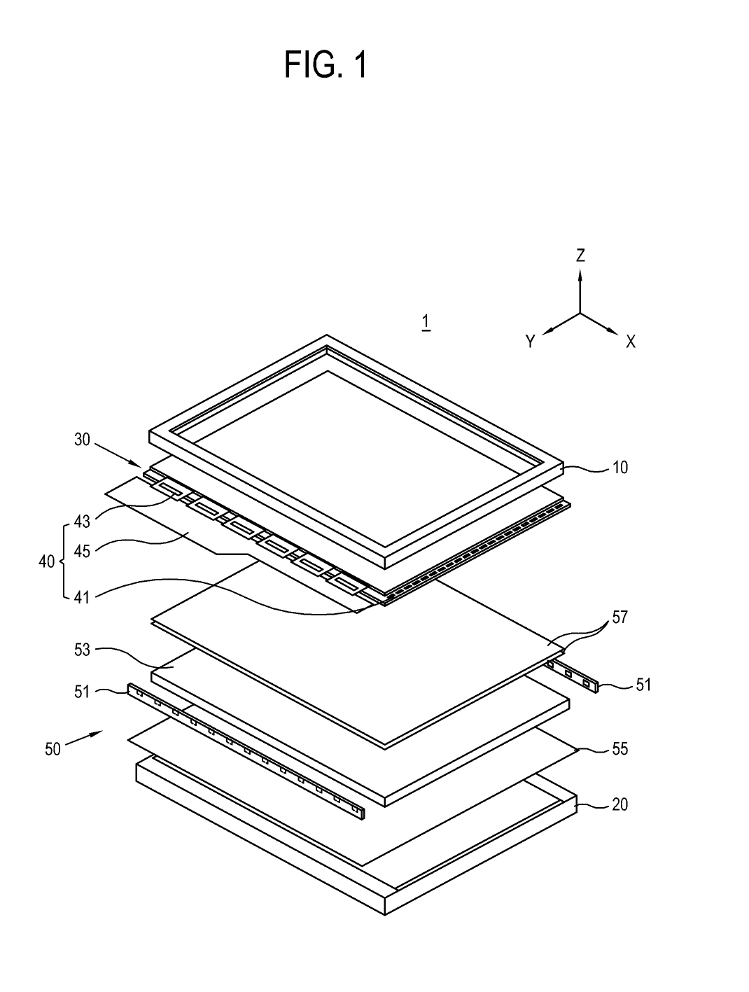

FIG. 1 is an exploded perspective view of a display apparatus 1 according to a first exemplary embodiment. In this exemplary embodiment, the display apparatus 1 includes a liquid crystal display (LCD) panel 30.

As shown in FIG. 1, the display apparatus 1 includes covers 10 and 20 which form an interior space, the display panel 30 situated in the interior space by the covers 10 and 20 and displaying images on a front surface thereof, a panel driver 40 driving the display panel 30, and a backlight 50 situated in the interior space by the covers 10 and 20 to face a rear surface of the display panel 30 and provides light to the display panel 30.

Directions shown in FIG. 1 are defined as follows. The X, Y, and Z directions of FIG. 1 indicate width, length, and height directions of the display panel 30, respectively. The display panel 30 is disposed parallel with an X-Y plane defined by an X-axis and a Y-axis, and the covers 10 and 20, the display panel 30 and the backlight 50 are stacked along a Z-axis. Here, opposite X, Y, and Z directions are expressed as −X, Y, and −Z directions, respectively.

Unless specified otherwise, the terms “upper” and “above” indicate the Z-direction, while the terms “lower” and “under” indicate the −Z direction. For example, the backlight t 50 is disposed under the display panel 30, and light radiated from the backlight 50 enters a lower surface of the display panel 30 and exits through an upper surface of the display panel 30.

The covers 10 and 20 form an outward shape of the display apparatus 1 and support the display panel 30 and the backlight 40 which are situated inside. Defining the Z direction as a front direction/front side and the −Z direction as a rear direction/rear side based on the display panel 30 in FIG. 1, the covers 10 and 20 include a front cover 10 which supports a front side of the display panel 30 and a rear cover 20 which supports a rear side of the backlight 50. The front cover 10 has an opening formed on a surface thereof parallel with the X-Y plane to expose an image display area of the display panel 30 there through.

The display panel 30 is configured as the LCD panel. The display panel 30 is formed of two substrates (not shown) and a liquid crystal layer (not shown) interposed there between and displays images on a surface thereof by adjusting arrangement of liquid crystals in the liquid crystal layer (not shown) through the application of driving signals. The display panel 30 does not emit light by itself and thus is provided with light from the backlight 50 in order to display images in the image display area.

The panel driver 40 applies a driving signal to drive the liquid crystal layer to the display panel 30. The panel driver 40 includes a gate drive integrated circuit (IC) 41, a data chip film package 43, and a printed circuit board (PCB) 45.

The gate drive IC 41 is integrally formed on a substrate (not shown) of the display panel 30 and is connected to each gate line (not shown) on the display panel 30. The data chip film package 43 is connected to each data line (not shown) formed on the display panel 30. The data chip film package 43 may include a wiring pattern, obtained by forming semiconductor chips on a base film, and a tape automated bonding (TAB) tape bonded by a TAB technique. The chip film package may include, for example, a tape carrier package (TCP) or a chip on film (COB). The PCB 45 inputs a gate drive signal to the gate drive IC 41 and inputs a data drive signal to the data chip film package 43.

With this configuration, the panel driver 40 respectively inputs drive signals to each gate line and each data line on the display panel 30 thereby driving the liquid crystal layer (not shown) on a pixel basis.

The backlight 50 may be disposed at rear of the display panel 30. In the −Z direction of the display panel 30, to provide light to the rear surface of the display panel 30. The backlight 50 includes a light source 51 disposed on an edge of the display panel 30, a light guide plate 53 disposed parallel with the display panel 30 to face the rear surface of the display panel 30, a reflection plate 55 disposed under the light guide plate 53 to face a lower surface of the light guide plate 53, and at least one optical sheet 57 disposed between the display panel 30 and the light guide plate 53.

This exemplary embodiment illustrates an edge-type backlight 50 in which the light source 51 is disposed at an edge of the light guide plate 53 and a light emitting direction of the light source 51 and a light exiting direction of the light guide plate 53 are perpendicular to each other. However, a structure of the backlight 50 may be variously changed or modified in design, without being limited to this exemplary embodiment. For example, a direct-type backlight 50 may be used in which the light source 51 is disposed under the light guide plate 53 the light emitting direction of the light source 51 and the light exiting direction of the light guide plate 53 are parallel with each other.

The light source 51 generates light and radiates the generated light to enter the light guide plate 53. The light source 51 is installed perpendicular to the surface of the display panel 30, that is, the X-Y plane, and disposed along at least one of four edges of the display panel 30 or the light guide plate 53. The light source 51 includes light emitting elements (not shown), configured as, for example, light emitting diodes (LEDs), sequentially disposed on a module substrate (not shown) in the X direction.

The light guide plate 53, which is a plastic lens formed of acrylic materials, uniformly guides light incident from the light source 51 to the entire image display area of the display panel 30. A lower side of the light guide plate 53 that is a side in the −Z direction faces the reflection plate 55. Among four side walls formed between an upper side and the lower side of the light guide plate 53 in four directions, side walls in the Y and −Y directions face the light source 51. Light radiated from the light source 51 enters the side walls in the Y and −Y directions.

The light guide plate 53 includes various optical patterns (not shown) formed on the lower side to diffuse-reflect light proceeding in the light guide plate 53 or change a traveling direction of the light, thereby uniformly distributing light which exits from the light guide plate 53.

The reflection plate 55 under the light guide plate 53 reflects light exiting from an inside of the light guide plate 53 to the outside, thus heading back toward the light guide plate 53. The reflection plate 55 reflects light not reflected by the optical patterns formed on the lower side of the light guide plate 53 back into the light guide plate 53. To this end, a surface of the reflection plate 55 in the Z direction has total reflection characteristics.

The at least one optical sheet 57 is stacked on the light guide plate 53 to adjust characteristics of light exiting from the light guide plate 53. The optical sheet 57 may include a diffusion sheet, a prism sheet and a protection sheet, among which two or more sheets may be stacked in combination considering ultimately desired light characteristics.

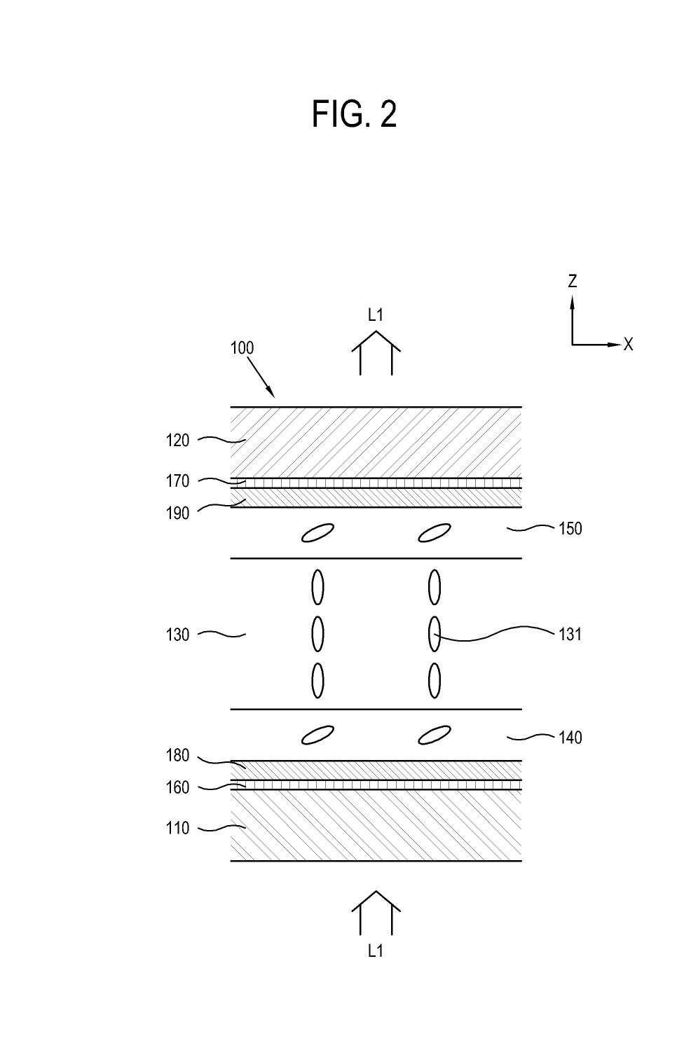

FIG. 2 is a cross-sectional view which illustrates a layered structure of elements of a display panel 100. The display panel 100 of FIG. 2 has a configuration substantially the same as the display panel 30 shown in FIG. 1 and thus may be also applied to the display apparatus 1 of FIG. 1.

As shown in FIG. 2, light L1 radiated in the Z direction from the backlight 50 (FIG. 1) enters the display panel 100 and exits in the Z direction via different elements of the display panel 100. In the following description, spatially relative terms, such as “upper,” “above,” “lower” and “under” may be used for ease of description to describe the relationship of one element or feature to another element(s) or feature(s) in arrangement or deposition based on the Z direction in which the light L1 proceeds.

The display panel 100 includes a lower substrate 110, an upper substrate 120 disposed to face the lower substrate 110, a liquid crystal layer 130 disposed between the lower substrate 110 and the upper substrate 120, pre-tilt layers 140 and 150 formed above and under the liquid crystal layer 130, a lower polarizing layer 160 disposed on an upper surface of the lower substrate 110, an upper polarizing layer 170 disposed on a lower surface of the upper substrate 120, a color filter layer 180 disposed between the liquid crystal layer 130 and the lower polarizing layer 160 and a retardation compensation film 190 disposed between the upper polarizing layer 170 and an upper pre-tilt layer 150.

In addition to the foregoing elements, additional elements including an electrode layer (not shown) are needed to constitute the display panel 100. However, only constituent elements directly related to the exemplary embodiment are illustrated herein for clarity and conciseness, which does not mean that only the illustrated elements are needed to configure the display panel 100.

The lower substrate 110 and the upper substrate 120 are transparent substrates disposed at a predetermined interval in the proceeding direction of the light L1; that is, the Z direction, to face each other. The lower substrate 110 and the upper substrate 120 may be formed of a glass or plastic substrate. As a plastic substrate, the lower substrate 110 and the upper substrate 120 may include polycarbonate, polyimide (PI), polyethersulphone (PES), polyacrylate (PAR), polyethylenenaphthelate (PEN), or polyethyleneterephehalate (PET).

The lower substrate 110 and the upper substrate 120 need to have different characteristics based on a drive method of the liquid crystal layer 130. For example, in a passive-matrix liquid crystal layer 130, the lower substrate 110 and the upper substrate 120 may include soda lime glass. In an active-matrix liquid crystal layer 130, the lower substrate 110 and the upper substrate 120 may include alkali free glass or borosilicate glass.

The liquid crystal layer 130 is disposed between the lower substrate 110 and the upper substrate 120 and adjusts light transmittance with a change in arrangement of the liquid crystals 131 based on an applied driving signal. A liquid generally includes molecules with irregular orientation and arrangement, while liquid crystals 131 are matter in a state with regularity to a certain extent, which is similar to a liquid phase. For example, there is a solid which becomes in a liquid phase which exhibits anisotropic properties such as birefringence in response to being heated and melted. Liquid crystals 131 have optical properties such as birefringence or color change. A liquid crystal is called such a name since the liquid crystal has properties of both liquid and solid crystal, for example, regularity as a crystal-like property and a liquid-like phase. In response to voltage being applied to the liquid crystals 131, arrangement of the molecules is changed and optical properties are also changed, accordingly.

The liquid crystals 131 in the liquid crystal layer 130 may be classified into nematic, cholesteric, smectice, and ferroelectric liquid crystals based on arrangement of the molecules.

The liquid crystal layer 130 may operate in a twisted nematic (TN) mode, a super twisted nematic mode (STN), an in-plane switching (IPS) mode or a vertical alignment (VA) mode based on an operating mode of the liquid crystals 131. In an exemplary embodiment, the liquid crystal layer 130 has a VA mode but may be implemented in a different mode depending on the design.

The pre-tilt layers 140 and 150 are formed above and under the liquid crystal layer 130, and include liquid crystals tilted in a particular direction so that the liquid crystals in the liquid crystal layer 130 rotate in the same direction or at the same angle in response to voltage being applied to the liquid crystal layer 130. For example, in the VA liquid crystal layer 130, in response to voltage not being applied to the liquid crystal layer 130, the liquid crystals 131 stand upright parallel with the Z direction. In response to voltage being applied to the liquid crystal layer 130, the liquid crystals 131 tilt in a particular direction with respect to the Z-axis. Here, the pre-tilt layers 140 and 150 adjust all liquid crystals 131 to tilt in the same direction.

The lower polarizing layer 160 formed on a surface of the lower substrate 110 in the Z direction; that is, a light L1 exiting surface of the lower substrate 110. The lower polarizing layer 160 transmits only a preset first polarizing-direction component of the radiated light L1 and reflects a component other than the first polarizing-direction component.

The upper polarizing layer 170 is formed on a surface of the upper substrate 120 in the −Z direction, that is, a light L1 entering surface of the upper substrate 120. The upper polarizing layer 170 transmits only a preset second polarizing-direction component of the radiated light L1 and reflects a component other than the second polarizing-direction component. A second polarizing direction is different from a first polarizing direction, and more particularly is perpendicular to the first polarizing direction.

The upper polarizing layer 170 and the lower polarizing layer 160 each include a linear grid (not shown) of a plurality of bars extending in one direction parallel with the X-Y plane on the surfaces of the upper substrate 120 and the lower substrate 110. In the linear grid, the bars are arranged at a preset interval with a pitch and the extending direction thereof corresponds to each polarizing direction. The linear grid (not shown) of the upper polarizing layer 170 projects from the upper substrate 120 to the liquid crystal layer 130, and the linear grid (not shown) of the lower polarizing layer 160 projects from the lower substrate 110 to the liquid crystal layer 130.

The color filter layer 180 converts light entering the display panel 100 into red, green and blue (RGB) colors of light. A pixel of the liquid crystal layer 130 includes sub-pixels which respectively correspond to the RGB colors, and the color filter layer 180 conducts filtering on each sub-pixel, by color. In an exemplary embodiment, the color filter layer 180 is disposed toward the lower substrate 110, without being limited thereto. Alternatively, the color filter layer 180 may be disposed toward the upper substrate 120, for example, between the upper polarizing layer 170 and the retardation compensation film 190.

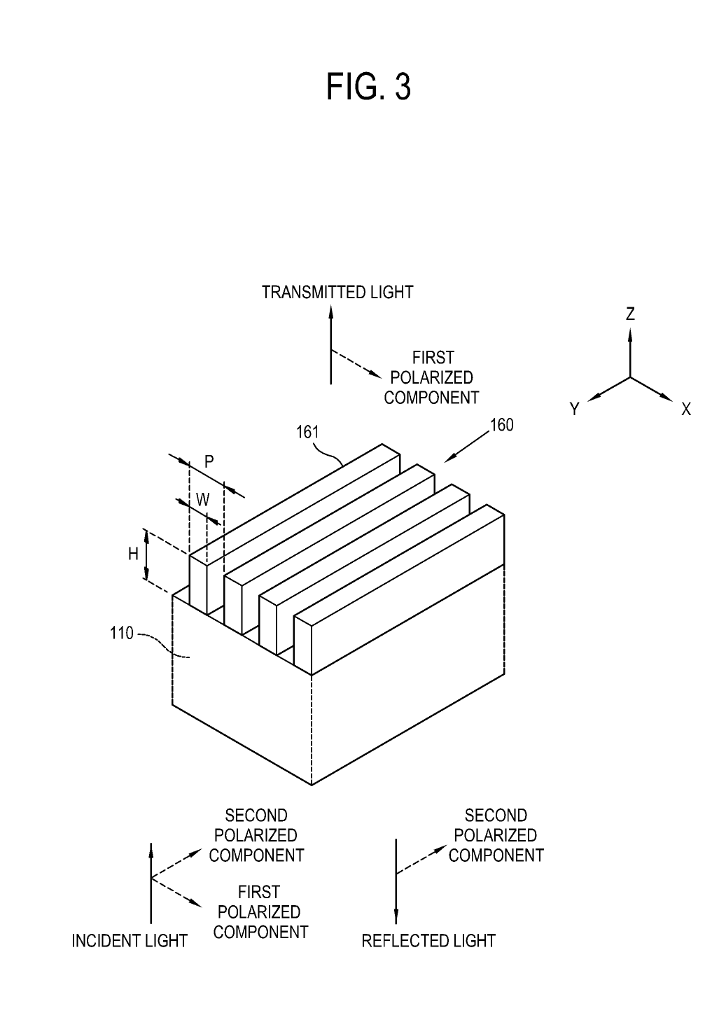

Hereinafter, a structure of the lower polarizing layer 160 will be described with reference to FIG. 3. Since the structure of the lower polarizing layer 160 may be applicable to the upper polarizing layer 170, description of the upper polarizing layer 170 will be omitted herein.

FIG. 3 is a perspective view which illustrates a main part of the lower polarizing layer 160.

As shown in FIG. 3, the lower polarizing layer 160 includes a wire grid or a linear grid in which a plurality of bars 161 project in the Z direction and extending in the Y direction are disposed parallel on the lower substrate 110. The bars 161 each have a preset height H and width W and are arranged regularly with a pitch P.

In response to the pitch P of the bars 161 being adjusted to ½ of a wavelength of light, only transmitted light and reflected light are formed without diffracted waves. A slit is formed between two adjacent bars 161, and while incident light is passing through the slit, a first polarized component in the first polarizing direction perpendicular to the extending direction of the bars 161 passes through the lower polarizing layer 160. To the contrary, a second polarized component in the second polarizing direction parallel with the extending direction of the bars 161 does not pass through the lower polarizing layer 160 but is reflected in the −Z direction. That is, due to this structure of the linear grid of the bars 161, light passing through the lower polarizing layer 160 is polarized-filtered in the first polarizing direction.

The reflected light, which does not pass through the lower polarizing layer 160, is reflected by the reflection plate 55 (FIG. 2) back to the display panel 100 along with light generated in the light source 51 (FIG. 2). That is, the light which does not pass but is filtered by the lower polarizing layer 160 may be reused, thereby improving overall efficiency of light passing through the display panel 100 without use of a conventional DBEF film.

The lower polarizing layer 160 is formed by depositing a metal layer on the lower substrate 110 and patterning the linear grid 161 by nanoimprint lithography (NIL). Polarized light of incident light is reflected by the lower polarizing layer 160 in response to being parallel with the grid, but is transmitted in response to being perpendicular to the grid.

To improve polarizing-filtering properties of the lower polarizing layer 160, an aspect ratio, i.e., a ratio of the width W of the bars 161 to the height H thereof, may be 1:3 or higher.

The upper polarizing layer 170 has a structure similar to the linear grid when compared to that of the lower polarizing layer 160. The linear grid of the upper polarizing layer 170 extends in a perpendicular direction to the linear grid 161 of the lower polarizing layer 160. For example, in response to the linear grid 161 of the lower polarizing layer 160 extending in the Y direction, the linear grid of the upper polarizing layer 170 extends in the X direction perpendicular to the Y direction. Accordingly, the upper polarizing layer 170 transmits only the second polarized component and does not transmit the first polarized component.

In the VA liquid crystal layer 130, in response to the user viewing an image on the display panel 100 from a center of the display panel 100, facing the Z-axis, the user recognizes the image without any difficulty. However, in response to the user viewing the image on the display panel from a lateral side of the display panel 100, leaning to the side with respect to the Z direction, light leakage wherein the radiated light L1 leaks, may occur. Light leakage occurs due to retardation of the radiated light L1, and accordingly the retardation compensation film 190 is needed to compensate for such retardation.

The retardation compensation film 190 adjusts a traveling speed of the radiated light L1; that is, delays a phase of the radiated light L1, thereby converting a polarization state of the light L1.

As described above, the display panel 100 includes the lower polarizing layer 160 and the upper polarizing layer 170 having the linear grids, and the lower polarizing layer 160 and the upper polarizing layer 170 are disposed between the lower substrate 110 and the upper substrate 120; that is, inside the display panel 100. In response to the retardation compensation layer 190 being disposed in a location that the light L1 passing through the upper polarizing layer 170 reaches, for example, on the upper surface of the upper substrate 120, the radiated light L1, which is already polarized and filtered, is subjected to retardation compensation, so that light leakage is not resolved.

Thus, the retardation compensation film 190 is dispose between the upper pre-tilt layer 150 and the upper polarizing layer 170. Accordingly, the radiated light L1 passing through the liquid crystal layer 130 and the pre-tilt layers 140 and 150 is subjected to retardation compensation prior to being polarized and filtered by the upper polarizing layer 170.

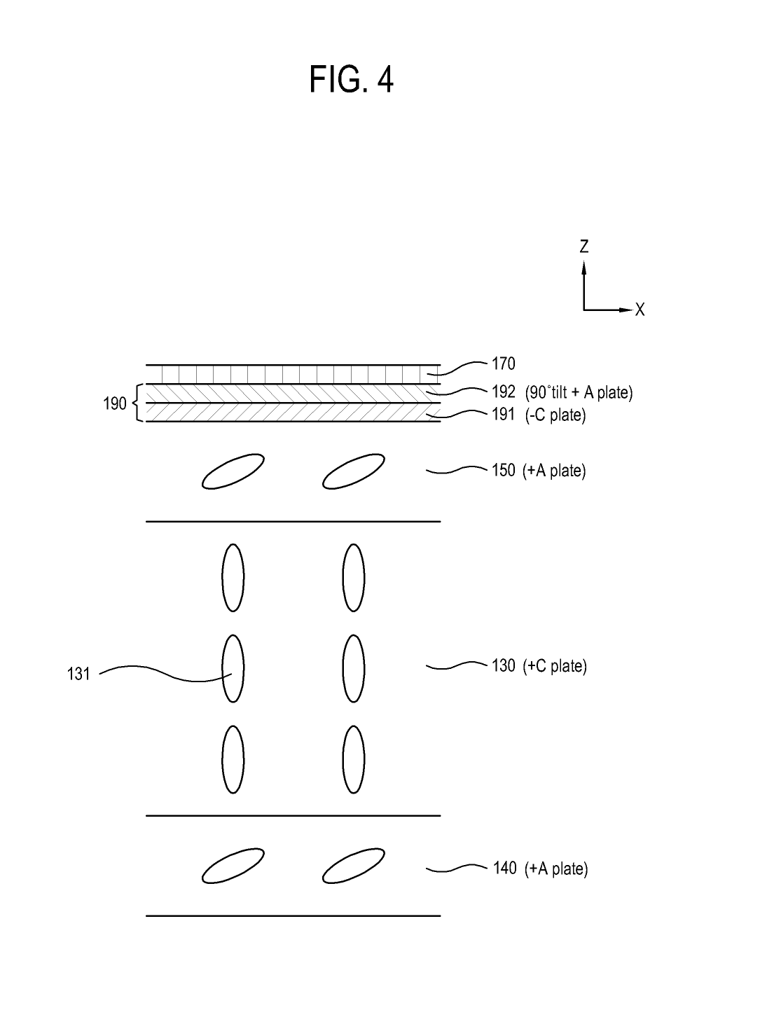

Hereinafter, a configuration of the retardation compensation film 190 will be described in detail with reference to FIG. 4.

FIG. 4 schematically illustrates relationship between the liquid crystal layer 130, the pre-tilt layers 140 and 150 and the retardation compensation film 190 in the display panel 100.

Referring to FIG. 4, the radiated light L1 proceeds in the Z direction, the pre-tilt layers 140 and 150 are disposed above and under the liquid crystal layer 130, and the retardation compensation film 190 is disposed above the pre-tilt layer 150.

The liquid crystals 131 in the liquid crystal layer 130 is a birefringent medium having different refractive indices in the Z direction and in a direction of the X-Y plane in response to liquid crystal molecules being placed in a spatial coordinate system. Defining a refractive index of the liquid crystals in the Z direction as n(e) and refractive index thereof in the direction of the X-Y plane as n(o), and n(e)>n(o).

Phase retardation characteristics include a C plate mode having an optical axis parallel with the Z-axis and an A plate mode having an optical axis parallel with an axis of the X-Y plane. Defining refractive index of a Z-direction component of light as n(Z), refractive index of an X-direction component of ht as n(X), and refractive index of a Y-direction component of light as n(Y), the C plate mode satisfies n(X)=n(Y)≠n(Z) and the A plate mode satisfies n(X)≠n(Y)=n(Z). The C plate mode may be divided into a +C plate mode and a −C plate mode, while the A plate mode may be divided into a +A plate mode and a −A plate mode.

In view of refractive index, the +C plate mode satisfies n(X)=n(Y)<n(Z) and the −C plate mode satisfies n(X)=n(Y)>n(Z). Thus, given the same amount of phase retardation of light, the +C plate mode and the −C plate mode are offset by each other.

In a similar manner, the +A plate mode satisfies n(Y)=n(Z)<n(X), and the −A plate mode satisfies n(Y)=n(Z)>n(X).

Modifications of the A plate mode having a 90-degree tilted optical axis of the A plate may be also applicable. A +A plate mode having a 90-degree tilted optical axis satisfies n(X)=n(Z)<n(Y), and a −A plate mode having a 90-degree tilted optical axis satisfies n(X)=n(Z)>n(Y).

The liquid crystal layer 130 has one of the phase retardation characteristics as described above, according to an operating mode. In the VA liquid crystal layer 130 of an exemplary embodiment, in response to the voltage not being applied, the liquid crystals 131 of the liquid crystal layer 130 stand upright parallel with the Z-axis to display a black image. On the contrary, in response to voltage being applied, the liquid crystals 131 tilt with respect to the Z-axis to display a white image. The VA liquid crystal layer 130 has a +C plate characteristic, while the pre-tilt layers 140 and 150 have a +A plate characteristic as the state of the liquid crystals is preset to guide an operation of the liquid crystals 131.

Thus, the retardation compensation film 190 may need to offset both phase retardation by the liquid crystal layer 130 and phase retardation by the pre-tilt layers 140 and 150. The retardation compensation film 190 includes a first compensation layer 191 having a negative phase retardation in contrast with a phase retardation mode of the liquid crystal layer 130 and a second compensation layer 192 having a phase retardation mode that is switched to the same phase retardation mode as that of the first compensation layer 191 in response to being combined with the pre-tilt layers 140 and 150.

For example, suppose that the phase retardation mode of the liquid crystal layer 130 is the +C plate mode and the phase retardation mode of the pre-tilt layers 140 and 150 is the +A plate mode. The first compensation layer 191 has the −C plate mode with a negative phase retardation in contrast with the +C plate mode. The second compensation layer 192 has the 90-degree tilted +A plate mode, which becomes the −C plate mode in response to being combined with the pre-tilt layers 140 and 150 having the +A plate mode.

That is, phase retardation of the liquid crystal layer 130 having the +C plate mode is offset by the first compensation layer 191 having the −C plate mode, and the second compensate layer 192 and the pre-tilt layers 140 and 150 having the −C plate mode in response to being combined with each other, thereby achieving light compensation.

Thicknesses of the first compensation layer 191 and the second compensation layer 192 are proportionate to the density of liquid crystals 131 per unit volume in the liquid crystal layer 130. Alternatively, thickness of the second compensation layer 192 is determined to retard the amount of light retarded by the pre-tilt layers 140 and 150, while the thickness of the first compensation layer 192 is determined to offset a phase difference of light retarded by the liquid crystal layer 130 in response to being combined with the second compensation layer 192.

For instance, suppose that the liquid crystal layer 130 has one hundred liquid crystals 131 per unit volume and the pre-tilt layers 140 and 150 each have ten liquid crystals; the second compensation layer 192 has a thickness proportionate to twenty liquid crystals as a total number of liquid crystals in the pre-tilt layers 140 and 150 per unit volume and accordingly retards the amount of light retarded by the twenty liquid crystals in the same way as by the first compensation layer 191. The first compensation layer 191 has a thickness proportionate to eighty liquid crystals 131, excluding the twenty liquid crystals offset by a combination of the second compensation layer 192 and the pre-tilt layers 140 and 150 from the hundred liquid crystals 131 per unit volume in the liquid crystal 130, thereby offsetting the amount of light retarded by the eighty liquid crystals 131.

This structure may prevent light leakage of a display panel having the linear grid structure and improve a viewing angle.

Although an exemplary embodiment has been illustrated with the VA liquid crystal layer 130, the liquid crystal layer 130 may operate in a different mode from the VA mode depending on the design. In this case, phase retardation modes of the pre-tilt layers 140 and 150, the first compensation layer 191 and the second compensation layer 192 may be determined based on an operating mode of the liquid crystal layer 130.

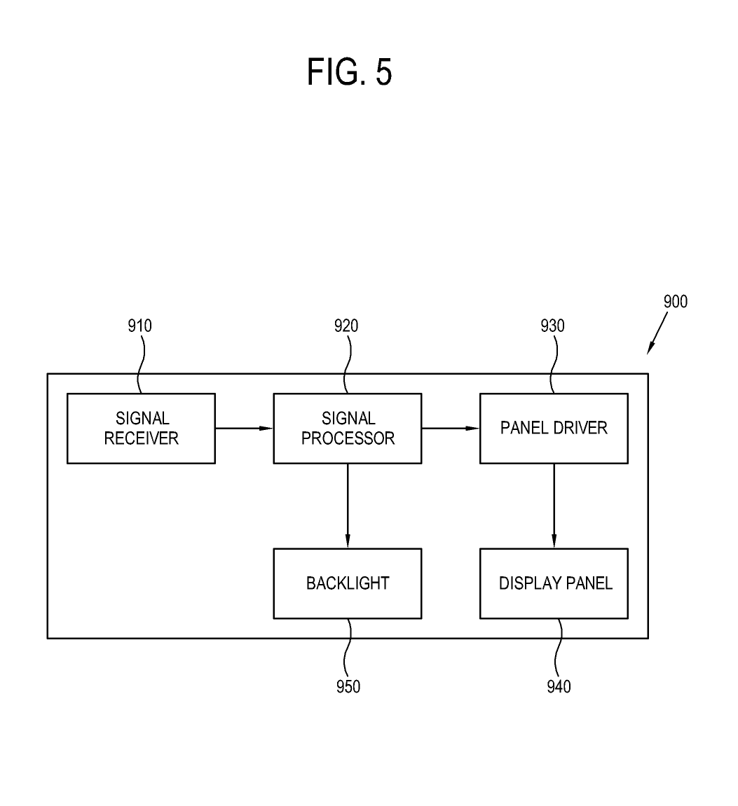

Hereinafter, a configuration of a display apparatus 900 according to a second exemplary embodiment will be described with reference to FIG. 5

FIG. 5 is a block diagram which illustrates the configuration of the display apparatus 900 according to another exemplary embodiment.

As shown in FIG. 5, the display apparatus 900 includes a signal receiver 910 which receives an image signal, a signal processor 920 processing the image signal received by the signal receiver 910 according to a preset image processing process, a panel driver 930 which outputs a driving signal corresponding to the image signal processed by the signal processor 920, a display panel 940 displaying an image based on the image signal in accordance with the driving signal from the panel driver 930, and a backlight 950 providing light to the display panel 940 which corresponds to the image signal processed by the signal processor 920.

In an exemplary embodiment, the display apparatus 900 may be configured as various devices capable of displaying images, for example, a TV, a monitor, a portable media player and a mobile phone.

The signal receiver 910 receives an image signal or image data and transmits the image signal or image data to the signal processor 920. The signal receiver 910 may be configured as various types based on standards of received image signals and configurations of the display apparatus 900. For example, the signal receiver 910 may receive a radio frequency (RF) signal transmitted from a broadcasting station (not shown) wirelessly or various image signals in accordance with composite video, component video, super video, SCART, high definition multimedia interface (HDMI), DisplayPort, unified display interface (UDI) or wireless HD standards via a cable. in response to the image signal being a broadcast signal, the signal receiver 910 includes a tuner to tune the broadcast signal by each channel. Alternatively, the signal receiver 910 may receive an image data packet from a server (not shown) through a network.

The signal processor 920 performs various image processing processes on the image signal received by the signal receiver 910. The signal processor 920 outputs a processed image signal to the panel driver 930, thereby displaying an image based on the image signal on the display panel 940.

The signal processor 920 may perform any kind image processing, without being limited to, for example, decoding which corresponds to an image format of image data, de-interlacing to convert interlaced image data into a progressive form, scaling to adjust image data to a preset resolution, noise reduction to improve image quality, detail enhancement, frame refresh rate conversion, or the like.

The signal processor 920 may be configured as an image processing board (not shown) formed by mounting an integrated multi-functional component, such as a system on chip (SOC), or separate components which independently conduct individual processes on a printed circuit board and be embedded in the display apparatus 900.

The panel driver 930, the display panel 940, and the backlight 950 have substantially the same configurations as those in the foregoing exemplary embodiment, and thus detailed descriptions thereof are omitted herein.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A liquid crystal display (LCD) panel comprising:
a lower substrate;
an upper substrate disposed to face the lower substrate;
a liquid crystal layer disposed between the lower substrate and the upper substrate and configured to operate in a first preset phase retardation mode based on an operating mode of liquid crystals of the liquid crystal layer;
a pre-tilt layer configured to guide a direction of rotation of the liquid crystals in response to the liquid crystal layer operating;
a polarizing layer formed on a surface of the upper substrate and having a wire grid structure to polarize and filter radiated light passing through the liquid crystal layer; and
a retardation compensation film disposed between the polarizing layer and the upper substrate and configured to compensate phase retardation of the radiated light caused by the liquid crystal layer and the pre-tilt layer,
wherein the retardation compensation film comprises:
a first compensation layer configured to retard the radiated light in a second phase retardation mode having a negative phase retardation in contrast with the first phase retardation mode of the liquid crystal layer; and
a second compensation layer configured to retard the radiated light in a third phase retardation mode which is switched to the second phase retardation mode in response to being combined with the pre-tilt layer.

2. The LCD panel of claim 1, wherein the thickness of the first compensation layer and the thickness of the second compensation layer are proportionate to the density of the liquid crystals per unit volume in the liquid crystal layer.

3. The LCD panel of claim 2, wherein the thickness of the second compensation layer is configured to retard an amount of light retarded by the pre-tilt layer, and the thickness of the first compensation layer is configured to offset a phase difference of light retarded by the liquid crystal layer in combination with the second compensation layer.

4. The LCD panel of claim 1, wherein the liquid crystal layer operates in any one of a twisted nematic (TN) mode, a super twisted nematic mode (STN), an in-plane switching (IPS) mode and a vertical alignment (VA) mode based on the operating mode of the liquid crystals.

5. The LCD panel of claim 1, wherein the phase retardation modes comprise a C plate mode and an A plate mode classified according to an optical axis, and in response to the liquid crystal layer operating in a VA mode, the first phase retardation mode of the liquid crystal layer is a +C plate mode, the phase retardation mode of the pre-tilt layer is a +A plate mode, the second phase retardation mode is a −C plate mode, and the third phase retardation mode is a +A plate mode having a 90-degree tilt optical axis.

6. The LCD panel of claim 5, wherein in response to the pre-tilt layer having the +A plate mode and the second compensation layer having the +A plate mode having the 90-degree tilt optical axis being combined, the radiated light is retarded by the −C plate mode.

7. A display apparatus comprising:
a display panel; and
a backlight configured to provide light to the display panel in order to display an image,
the display panel comprising:
a lower substrate;
an upper substrate disposed to face the lower substrate;
a liquid crystal layer disposed between the lower substrate and the upper substrate and configured to operate in a first preset phase retardation mode based on an operating mode of liquid crystals of the liquid crystal layer;
a pre-tilt layer configured to guide a direction of rotation of the liquid crystals in response to the liquid crystal layer operating;
a polarizing layer formed on a surface of the upper substrate and having a wire grid structure to polarize and filter radiated light passing through the liquid crystal layer; and
a retardation compensation film disposed between the polarizing layer and the upper substrate and configured to compensate phase retardation of the radiated light caused by the liquid crystal layer and the pre-tilt layer,
the retardation compensation film comprising:
a first compensation layer configured to retard the radiated light in a second phase retardation mode having a negative phase retardation in contrast with the first phase retardation mode of the liquid crystal layer; and
a second compensation layer configured to retard the radiated light in a third phase retardation mode which is switched to the second phase retardation mode in response to being combined with the pre-tilt layer.

8. The display apparatus of claim 7, wherein the thickness of the first compensation layer and the thickness of the second compensation layer are proportionate to the density of the liquid crystals per unit volume in the liquid crystal layer.

9. The display apparatus of claim 8, wherein the thickness of the second compensation layer is configured to retard an amount of light retarded by the pre-tilt layer and the thickness of the first compensation layer is configured to offset a phase difference of light retarded by the liquid crystal layer in combination with the second compensation layer.

10. The display apparatus of claim 7, wherein the liquid crystal layer operates in any one of a twisted nematic (TN) mode, a super twisted nematic mode (STN), an in-plane switching (IPS) mode and a vertical alignment (VA) mode based on the operating mode of the liquid crystals.

11. The display apparatus of claim 7, wherein the phase retardation modes comprise a C plate mode and an A plate mode classified according to an optical axis, and in response to the liquid crystal layer operating in a VA mode, the first phase retardation mode of the liquid crystal layer is a +C plate mode, the phase retardation mode of the pre-tilt layer is a +A plate mode, the second phase retardation mode is a −C plate mode, and the third phase retardation mode is a +A plate mode having a 90-degree tilt optical axis.

12. The display apparatus claim 11, wherein in response to the pre-tilt layer having the +A plate mode and the second compensation layer having the +A plate mode having the 90-degree tilt optical axis being combined, the radiated light is retarded by the −C plate mode.

13. A display panel comprising:
a liquid crystal layer configured to operate in a first preset phase retardation mode;
a pre-tilt layer configured to guide a rotation direction of the liquid crystals;
a polarizing layer having a wire grid structure to polarize and filter radiated light passing through the liquid crystal layer; and
a retardation compensation film configured to compensate phase retardation of the radiated light,
the retardation compensation film comprising:
a first compensation layer configured to retard the radiated light in a second phase retardation mode having a negative phase retardation in contrast with the first phase retardation mode of the liquid crystal layer; and
a second compensation layer configured to retard the radiated light in a third phase retardation mode which is switched to the second phase retardation mode in response to being combined with the pre-tilt layer.

14. The display panel of claim 13, wherein the phase retardation modes comprise a C plate mode and an A plate mode classified according to an optical axis, and in response to the liquid crystal layer operating in a VA mode, the first phase retardation mode of the liquid crystal layer is a +C plate mode, the phase retardation mode of the pre-tilt layer is a +A plate mode, the second phase retardation mode is a −C plate mode, and the third phase retardation mode is a +A plate mode having a 90-degree tilt optical axis, wherein in response to the pre-tilt layer having the +A plate mode and the second compensation layer having the +A plate mode having the 90-degree tilt optical axis being combined, the radiated light is retarded by the −C plate mode.
